(19) United States
(12) Patent Application Publication
(10) Pub. No.: US 2007/0195186 A1
(43) Pub. Date: Aug. 23, 2007

(54) Digital camera

(75) Inventor: Masaru Okada, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/707,900

(22) Filed: Feb. 20, 2007

(30) Foreign Application Priority Data
Feb. 22, 2006 (JP) 2006-044676

(51) Int. Cl. H04N 5/222

(52) U.S. Cl. 348/333.02

(57) ABSTRACT

A digital camera provided with an image pickup unit having an image pickup device and an image processing unit that apply image processing to an image pickup signal outputted from the image pickup unit according to setting values of image quality adjustment parameters is disclosed. The digital camera includes: a displaying unit capable of displaying a plurality of languages; a language selecting unit for selecting one of the plurality of languages to be displayed by the displaying unit; a setting value storing unit for storing the setting values of the image quality adjustment parameters respectively associated with the plurality of languages; and a retrieving unit for retrieving the setting values associated with the language selected through the language selecting unit from the setting value storing unit. The image processing unit carries out the image processing according to the setting values retrieved from the setting value storing unit.

### BACKGROUND OF THE INVENTION

1. Field of the Invention

The present invention relates to a digital camera, and particularly to setting values of image adjustment parameters.

2. Description of the Related Art

In typical digital cameras, setting values of image quality adjustment parameters, such as white balance (WB), tone, lightness, hue and sharpness, are conventionally set to standard levels before shipment. However, since impression of images, or taste for images varies from person to person, images taken with digital cameras with the pre-setting as described above may not satisfy some users. In order to address this problem, digital cameras, which are provided with a function that allows each user to modify some of the parameters so that the user can obtain images of his or her taste, have been known. Further, U.S. Patent Application Publication No. 20010020978 discloses an electronic camera, in which image quality settings of images can be reset after the images have been taken without causing degradation of image quality.

It is known that impression of, or taste for images varies not only on person-to-person basis, but also varies depending on the living environment, i.e., from country to country or from nation to nation, and there are different tendencies of taste for images for the respective countries and/or nations. Therefore, images taken with digital cameras with the image quality adjustment parameters set to certain standard levels before shipment, as described above, may not satisfy many of users in different countries or of different nations.

### SUMMARY OF THE INVENTION

In view of the above-described circumstances, the present invention is directed to provide a digital camera that allows automatic selection of setting values of image quality adjustment parameters that reflect tendency of taste for images of average people in each country or of each nation, regardless of the country or region to which the digital camera is shipped.

The digital camera of the present invention is provided with an image pickup means having an image pickup device that converts an optical image into an electric signal, and an image processing means that apply image processing to an image pickup signal outputted from the image pickup means according to setting values of image quality adjustment parameters, and the digital camera comprises: a displaying means capable of displaying a plurality of languages; a language selection means for selecting one of the plurality of languages to be displayed by the displaying means; a setting value storing means for storing the setting values of the image quality adjustment parameters respectively associated with the plurality of languages; and a retrieving means for retrieving the setting values associated with the language selected through the language selection means from the setting value storing means, wherein the image processing means carries out the image processing according to the setting values retrieved from the setting value storing means.

In the digital camera of the invention, the parameters may be white balance adjustment parameters.

In the digital camera of the invention, the parameters may be sharpness adjustment parameters.

In the digital camera of the invention, the parameters may be gamma correction parameters.

### BRIEF DESCRIPTION OF THE DRAWINGS

FIG. 1 is a perspective view showing a back side of a digital camera of the present embodiment;

FIG. 2 is a block diagram showing a schematic internal configuration of the digital camera of the present embodiment;

FIGS. 3A and 3B show gamma correction curves of the present embodiment;

FIG. 4 is a flowchart of a language selection operation of the digital camera of the present embodiment; and

FIGS. 5A-5C show one example of operation screens of the digital camera of the present embodiment.

### DESCRIPTION OF THE PREFERRED EMBODIMENTS

Hereinafter, a digital camera 1 of an embodiment according to the present invention will be described in detail with reference to the drawings.

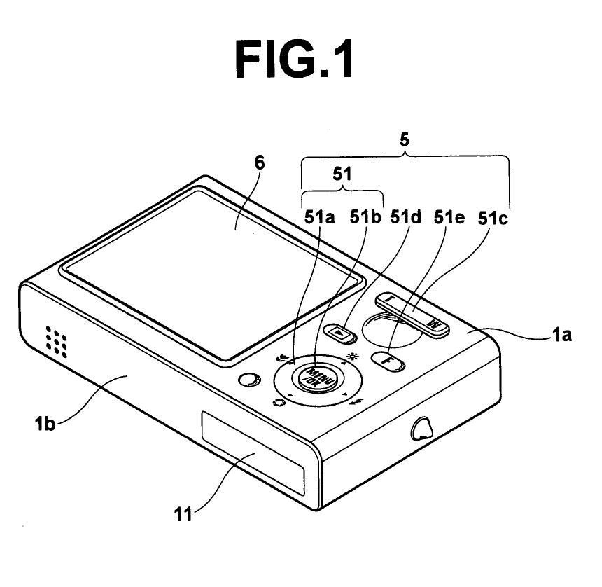

FIG. 1 is a perspective view showing a back side of the digital camera 1 of the present embodiment. It should be noted that the description of the digital camera 1 of the present embodiment will be given with referring to a side thereof having a lens as the front side and the other side thereof having an LCD (liquid crystal display) monitor as the back side. Although not illustrated in the drawings, the digital camera 1 includes typical devices necessary for photographing, such as a lens, a flash lamp, an auxiliary lamp and various sensors, at the front side thereof. As shown in FIG. 1, the digital camera 1 includes, at the back side 1a and a lower side 1b thereof, an LCD monitor 6 (a displaying means), a manipulation unit 5 (a manipulation means), a media slot 11, and the like. The LCD monitor 6 displays images recorded in a memory card (a recording medium) (not shown) loaded in a media slot 11, menu screens necessary for various settings, a live view of image information obtained by a CCD (not shown) during photographing, and the like. The menu screens can be displayed selectively in one of a plurality of languages, such as Japanese and English.

The manipulation unit 5 includes a four-directional button 51a used for selecting an item to be set in the menu screens for various settings displayed on the LCD monitor 6 by moving an element such as “highlight” in the menu screen in the direction of up, down, right or left, a MENU/OK button 51b used for displaying the menu screen or making decision on a selection of an item to be set, and the like. The manipulation unit 5 may further include a zoom button 51c, a play-back button 51d, a photo-mode button 51e, and the like, as necessary. It should be noted that the configuration of the manipulation unit 5 in the present invention is not limited to the above-described configuration, and the manipulation unit 5 may take any form as long as it allows a user to set various items. For example, the manipulation unit 5 may be in a form of a touch panel provided on the surface of the LCD monitor 6 displaying various items to be set, and a user may press the touch panel on one of the items to be set to select the item.

The media slot 11 receives a recording medium such as a memory card or an IC memory loaded thereto. When the recording medium is loaded in the media slot 11, data can be read from or written in the recording medium.

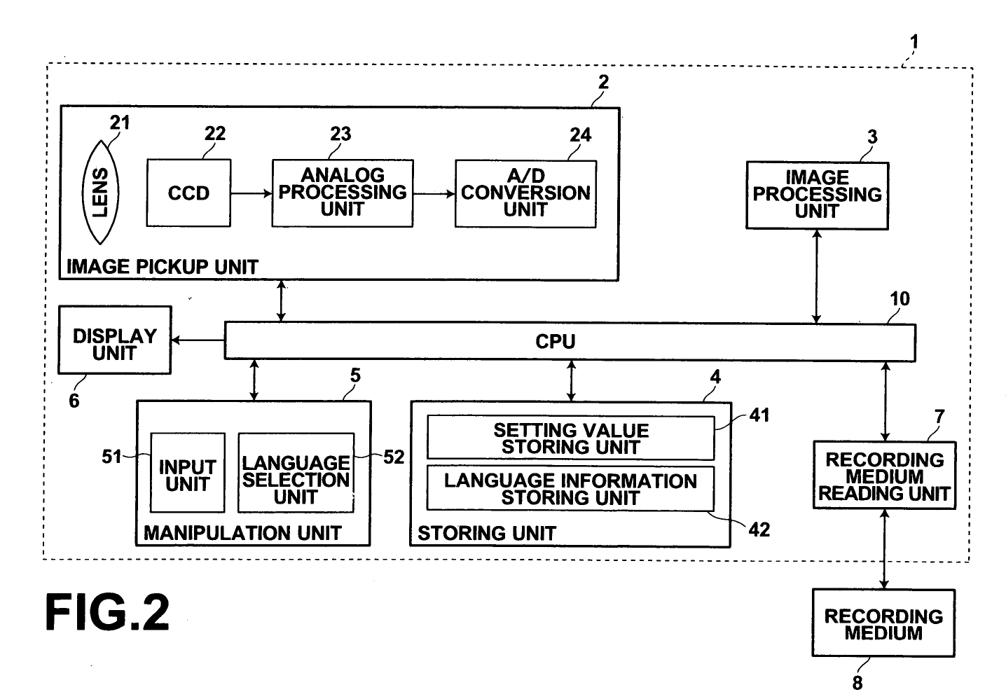

FIG. 2 is a block diagram illustrating a schematic configuration of the digital camera 1 of the present embodiment.

As shown in FIG. 2, the digital camera 1 of the present embodiment is generally formed by a CPU 10, an image pickup unit 2 (an image pickup means), an image processing unit 3 (an image processing means), a storing unit 4 (a storing means), the manipulation unit 5 (the manipulation means), a display unit 6 (the displaying means) and a recording medium reading unit 7 (a recording medium reading means).

The CPU 10 totally controls the digital camera 1 based on user inputs through the manipulation unit 5. The CPU 10 operates as a retrieving unit (a retrieving means) that retrieves data stored in the storing unit 4 according to instructions from the user through the manipulation unit 5, and also operates as an operation controlling unit that controls zooming, focusing (AF) and automatic exposure adjustment (AE) operations of a lens driving unit (described later) as well as a display controlling unit (a display controlling means) that controls the screens displayed on the display unit 6.

The image pickup unit 2 includes a photographing lens 21, the lens driving unit (not shown), a CCD 22 serving as an image pickup device, a CCD driving unit (not shown), an analog processing unit 23, an A/D conversion unit 24, and other necessary elements. An image of a subject focused on a light-receiving surface of the CCD 22 through the photographing lens 21 is converted by each sensor of the CCD 22 into a signal charge of an amount corresponding to the amount of incident light. It should be noted that the CCD 22 is provided with a so-called electronic shutter function that controls a charge accumulation time (a shutter speed) of each sensor by controlling timing of a shutter gate pulse.

The signal charge accumulated at each sensor is sequentially read from the CCD 22 as a voltage signal (analog image pickup signal) corresponding to the signal charge, based on a pulse applied by the CCD driving unit. The analog image pickup signals outputted from the CCD 22 are sent to the analog processing unit 23.

The analog processing unit 23 includes signal processing circuits such as a sampling and hold circuit, a color separation circuit and a gain control circuit. At this analog processing unit 23, the analog image pickup signals are subjected to correlation double sampling (CDS) and color separation into R, G and B color signals, and the signal level of each color signal is adjusted (pre-white balance processing).

The signals outputted from the analog processing unit 23 are converted into digital signals by the A/D conversion unit 24, and then are sent to the image processing unit 3. It should be noted that the CCD driving unit, the analog processing unit 23 and the A/D conversion unit 24 are driven synchronously by timing signals applied by a timing generator according to instructions from the CPU 10.

The image processing unit 3 is formed by a digital signal processor (DSP) containing image quality adjustment circuits such as a luminance/color-difference signal generating circuit, a gamma correction circuit, a sharpness adjustment circuit, a contrast correction circuit and a white balance adjustment circuit, where the image signals are processed according to the setting values of the image quality adjustment parameters stored in the setting value storing unit 41 and retrieved therefrom based on instructions from the CPU 10.

The storing unit 4 is a storage medium that can store various data and is formed, for example, by a magnetic or optical storage medium or a semiconductor memory. The storing unit 4 stores a system program for operating the digital camera, and also includes a language information storing unit 42 that stores information of a plurality of languages such as, for example, Japanese and English to be displayed on the display unit 6, and a setting value storing unit 41 (a setting value storing means) that stores setting value tables in which the plurality of languages are associated with their corresponding setting values of the image quality adjustment parameters.

The setting value storing unit 41 stores, as the setting values of the image quality adjustment parameters, white balance adjustment parameter setting values, sharpness adjustment parameter setting values and gamma correction parameter setting values.

The stored white balance adjustment parameter setting values include setting values associated with the Japanese language and setting values associated with the English language. The setting values associated with the Japanese language are determined so that images taken under lighting with low color temperature become more yellowish than those taken according to the setting values associated with the English language. The setting values associated with the English language are determined so that images taken under the lighting with low color temperature become less yellowish than those taken according to the setting values associated with the Japanese language.

For example, as the white balance adjustment parameter setting values, default setting values, the setting values associated with the Japanese language that yield images more yellowish than those taken at the default setting values, and the setting values associated with the English language that yield images less yellowish than those taken at the default setting values can be stored.

More specifically, for example, as the white balance adjustment parameter setting values associated with the Japanese language, setting values that yield images, taken under the lighting with low color temperature, with a tinge of yellow, and setting values associated with the English language that yield images, taken under the lighting with low color temperature, without a tinge of yellow can be stored.

In this manner, for the images taken under the lighting with low color temperature, different white balance adjustment parameter values can be set for the Japanese language settings used by Japanese people who generally tend to prefer pictures with a tinge of yellow, and for the English language settings used by American and European people who generally tend to be displeased by pictures with a tinge of yellow.

Further, the stored sharpness adjustment parameter setting values also include setting values associated with the Japanese language and setting values associated with the English language. The setting values associated with the Japanese language apply stronger sharpness adjustment than the setting values associated with the English language do. The setting values associated with the English language apply weaker sharpness adjustment than the setting values associated with the Japanese language do. In other words, the setting values associated with the Japanese language are set to enhance the sharpness more than the setting values associated with the English language do.

For example, as the sharpness adjustment parameter setting values, default setting values, the setting values associated with the Japanese language that enhance the sharpness more than the default setting values, and the setting values associated with the English language that make the sharpness weaker than the default setting values can be stored.

In this manner, different sharpness adjustment parameter values can be set for the Japanese language settings used by Japanese people who generally tend to prefer pictures with enhanced outlines, as typically represented by Ukiyo-e (Japanese old wood block prints) and comics, and for the English language settings used by American and European people who generally tend to prefer pictures with ambiguous outlines, as typically represented by Impressionistic paintings.

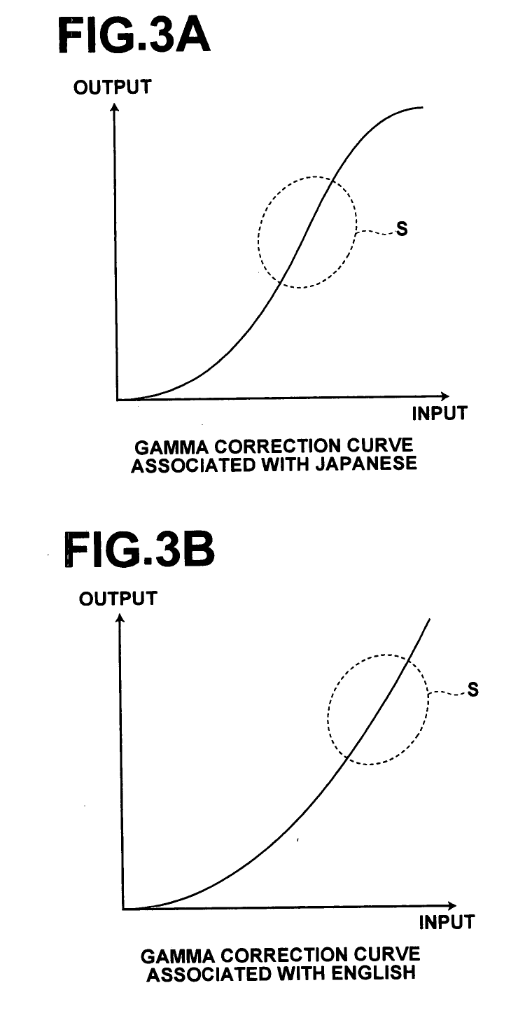

Furthermore, the stored gamma correction parameter setting values also include setting values associated with the Japanese language and setting values associated with the English language. FIG. 3A shows a gamma correction curve associated with the Japanese language and FIG. 3B shows a gamma correction curve associated with the English language. The symbol “S” in each drawing indicates a point having the highest linearity in each gamma correction curve.

As shown in FIGS. 3A and 3B, the setting values associated with the Japanese language put more importance on linearity, i.e., tone reproducibility, in low density areas than the setting values associated with the English language do. In contrast, the setting values associated with the English language put more importance on linearity, i.e., tone reproducibility, in high density areas than the setting values associated with the Japanese language do.

For example, as the gamma correction parameter setting values, default setting values, the setting values associated with the Japanese language that put more importance on linearity (tone reproducibility) in low density areas than the default setting values do, and the setting values associated with the English language that that put more importance on linearity (tone reproducibility) in high density areas than the default setting values do can be stored.

In this manner, different gamma correction parameter values can be set for the Japanese language settings used by Japanese people who generally tend to prefer images with low contrast in high density areas, or so-called soft gradation images, and for the English language settings used by American and European people who generally tend to prefer images with high contrast in high density areas, or so-called hard gradation images.

The thus set white balance adjustment parameter setting values, sharpness adjustment parameter setting values and gamma correction parameter setting values associated with the Japanese language and with the English language are stored in the setting value storing unit 41.

It should be noted that, although the white balance adjustment parameter setting values, the sharpness adjustment parameter setting values and the gamma correction parameter setting values are stored as the setting values of the image quality adjustment parameters in the above described embodiment, setting values stored in the digital camera of the present invention are not limited to these setting values, and may include, for example, one or two of the white balance adjustment parameter setting values, the sharpness adjustment parameter setting values and the gamma correction parameter setting values, or setting values of other image quality adjustment parameters.

In addition, the setting values of the image quality adjustment parameters stored in the setting value storing unit 41 of the present invention may not necessarily be those associated with the Japanese language and the English language. The setting values of the image quality adjustment parameters which are associated with any of languages selectable by a later-described language selection unit 52, for example, Japanese, English, Chinese, Korean, French, Spanish and German, and which respectively reflect the tendencies of taste of people having different nationalities who use these languages can be stored.

The manipulation unit 5 includes an input unit 51 formed by the four-directional button 51a and the MENU/OK button 51b described above, and the language selection unit 52 that selects one of the languages based on a user input via the input unit 51 and causes the selected language to be displayed on the LCD monitor 6 (the display unit). The input unit 51 and the language selection unit 52 form a language selection means.

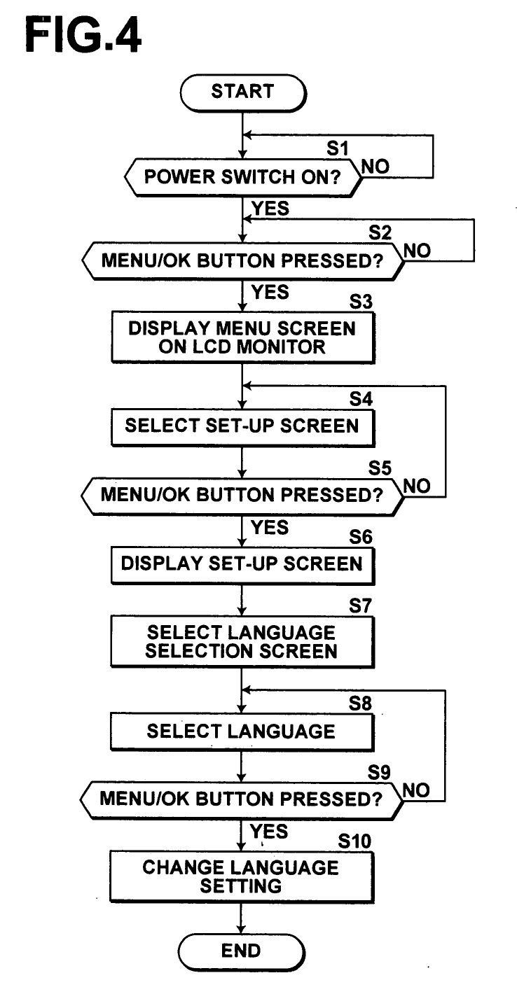

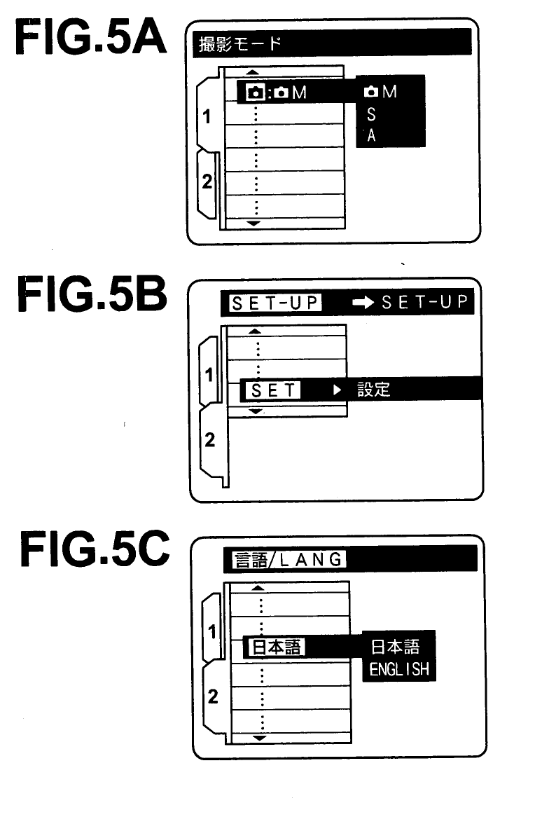

Now, the operation of the language selection means is described specifically. FIG. 4 shows a flowchart of a language selecting operation of the digital camera 1 and FIGS. 5A-5C show one example of operation screens. In the operation screens, upper, lower, right and left sides in the drawing are referred to as the upper, lower, right and left sides for convenience.

First, in a state where a power switch (not shown) of the digital camera 1 is turned on (step S1: YES), the user presses the MENU/OK button Sib (step S2: YES) to cause the LCD monitor 6 to display a menu screen as shown in FIG. 5A (step S3). As the menu screen has been displayed, the user presses the upper or lower side of the four-directional button 51a to select “SET-UP” as shown in FIG. 5B (step S4), and then presses the MENU/OK button Sib (step S5: YES) to display a SET-UP screen (step S6). Subsequently, the user presses the upper or lower side of the four-directional button 51a to select a language selection screen (step S7), and presses the right side of the four-directional button 51a to enter a state where the language can be selected, as shown in FIG. 5C. The user further presses the upper or lower side of the four-directional button 51a to select “ENGLISH” or the Japanese word meaning “Japanese” displayed on the screen (step S8). When the user presses the MENU/OK button 51b (step S9: YES) after the language has been selected, the setting of the language is changed (step S10). In this manner, the user selects the language which he or she uses.

It should be noted that, although the language selection means that operates as described above is used in the digital camera 1 of the present embodiment, the form of the language selection means in the digital camera 1 of the present invention is not limited to the one described above, and may take any form that allows the user to select the language which he or she uses. For example, a dedicated button for language selection may be provided, for example, on the back side 1a of the digital camera 1. Further, although the display unit 6 of the present embodiment can display the menu screens and the like in Japanese and English, the languages displayable on the display unit 6 of the present invention are not limited to Japanese and English, and the display unit 6 may display, for example, at least two of the languages such as Chinese, Korean, French, Spanish and German.

The feature of the present invention is that, as the language has been selected through the language selection means as described above, the setting values of the image quality adjustment parameters associated with the selected language are retrieved from the setting value storing unit 41 by the retrieving unit of the CPU 10, and the retrieved setting values are used in the image processing unit 3. In this manner, as the user selects the language which he or she uses, image processing is carried out according to the setting values of the image quality adjustment parameters associated with the selected language. Thus, the user can automatically select the setting values of the image quality adjustment parameters suitable for the average taste of people in his or her country or nation, and obtain images that meet his or her taste without conducting complicated setting operations.

The image data subjected to image processing based on the setting values associated with the selected language is stored in the storing unit 4, and when the taken images are to be displayed, the data is retrieved from the storing unit 4 and is outputted to the display controlling unit (CPU) according to instructions from the CPU 10.

The image data sent to the display controlling unit is converted into a display signal according to a certain system (for example, NTSC color composite vide signal), and then is outputted to the LCD monitor 6. Thus, the image content of the image data is displayed on the screen of the LCD monitor 6.

The image data subjected to image processing and stored in the storing unit 4 is updated at fixed intervals with new image data outputted from the CCD 22 and processed by the image processing unit 3, and the video signal generated from the image data is supplied to the LCD monitor 6, thereby the image inputted through the CCD 22 is displayed on the LCD monitor 6 in a real-time manner. The user can check the image of the subject by viewing the image (live view) displayed on the LCD monitor 6.

When the user finds a desired subject image and provides an instruction to record the image via a shutter button (not shown) in the manipulation unit 5, the image data stored in the storing unit 4 at that time is compressed according to a predetermined format, such as JPEG, by a compression/decompression circuit (not shown) and is recorded in the recording medium 8 via the recording medium reading unit 7.

The recording medium 8 may be any of various media that can be read and written according to electronic, magnetic or optical systems or combination of these systems, such as xD-Picture Card (R), Smart Media (R), PC card, Compact Flash (R), magnetic disk, optical disk, magneto optical disk, and Memory Stick (R). Then, a signal processing means and an interface suitable for the medium to be used are applied. The means for recording the images is not limited to a recording medium that can be attached to and removed from the body of the digital camera 1, and may be a recording medium built in the digital camera 1, i.e., an internal memory.

The digital camera of the present invention is provided with the displaying means that can display the menu or the like in a plurality of languages, the language selection means that selects one of the languages to be displayed by the displaying means, the setting value storing means that stores the setting values of the image quality adjustment parameters respectively associated with the plurality of languages, and the retrieving means that retrieves the setting values associated with the selected language from the setting value storing means, wherein the image processing means carries out image processing according to the setting values retrieved from the setting value storing means. Therefore, once the user selects the language which he or she uses, image processing is carried out according to the setting values of the image quality adjustment parameters associated with the selected language. Thus, the user can automatically select the setting values of the image quality adjustment parameters suitable for the average taste of people in his or her country or nation, and obtain images that meet his or her taste without conducting complicated setting operations.

What is claimed is:

1. A digital camera provided with an image pickup means having an image pickup device that converts an optical image into an electric signal, and an image processing means that apply image processing to an image pickup signal outputted from the image pickup means according to setting values of image quality adjustment parameters, the digital camera comprising:
a displaying means capable of displaying a plurality of languages;
a language selection means for selecting one of the plurality of languages to be displayed by the displaying means;
a setting value storing means for storing the setting values of the image quality adjustment parameters respectively associated with the plurality of languages; and
a retrieving means for retrieving the setting values associated with the language selected through the language selection means from the setting value storing means,
wherein the image processing means carries out the image processing according to the setting values retrieved from the setting value storing means.

2. The digital camera as claimed in claim 1, wherein the parameters comprise white balance adjustment parameters.

3. The digital camera as claimed in claim 1, wherein the parameters comprise sharpness adjustment parameters.

4. The digital camera as claimed in claim 1, wherein the parameters comprise gamma correction parameters.
